(19) United States
(12) Patent Application Publication
(10) Pub. No.: US 2025/0136506 A1
(43) Pub. Date: May 1, 2025

(54) THERMALLY BONDED GRANULATE

(71) Applicant: ROCKPORE AS, Vestskogen (NO)

(72) Inventors: Finn Erik SOLVANG, Vestskogen (NO); Knut Berg HAUGEN, Nøtterøy (NO)

(21) Appl. No.: 18/835,192

(22) PCT Filed: Feb. 8, 2023
(86) PCT No.: PCT/NO2023/050030

§ 371 Date: Aug. 1, 2024

(30) Foreign Application Priority Data
Feb. 8, 2022 (NO) 20220179

(51) Int. Cl. C04B 18/02; C04B 14/22; C04B 111/00; E01C 7/30; E01C 13/08

(52) U.S. Cl. CPC C04B 18/021; C04B 14/22; E01C 13/08; C04B 2111/00663; E01C 7/30

(57) ABSTRACT

The present invention concerns a thermally bonded granulate, where the thermally bonded granulate comprises 10-50 wt % of a mineral powder and 40-88 wt % of a bonding agent. The thermally bonded granulate further comprises 1-4 wt % of a strength-enhancing agent and 1-4 wt % of a density-reducing agent. The present invention further concerns the use of the thermally bonded granulate, and a method for producing the thermally bonded granulate.

### TECHNICAL FIELD

The present invention relates to filler materials. More specifically, the present inventions relates to thermally bonded granulates, the use of thermally bonded granulates and methods for manufacturing thermally bonded granulates.

### BACKGROUND

Filler materials are utilized across a range of industries, such as the artificial turf industry and the concrete industry, amongst others. Artificial turf may be used as a replacement for natural grass on sports fields, in domestics lawns and/or for commercial applications. Artificial turf usually includes synthetic fibers, mimicking natural grass straws. The synthetic fibers are supplemented with a loose filler material, or infill, dispersed between the synthetic fibers. Artificial turf may require from 4.5-45 kg of infill per square meter, depending on the type of use. The infill normally includes natural sand, and rubber granules, sourced from recycled car tires.

At least two serious problems arise with the use of rubber granules as infill. Firstly, heavy metals originating from the recycled car tires may form a health hazard for end-users of the artificial turf, such as athletes and trainers. Secondly, rubber granules, or fragments thereof, may be inadvertently transported into the surrounding environment. There, the rubber granules may be broken down into microplastics, forming a source of pollution of both land-based and aquatic eco-systems. Consequently, it is highly likely that stricter regulation may prohibit, or at least severely limit, the use of rubber granules as infill in artificial turf. Consequently, the artificial turf industry has a clear incentive to find alternative infill materials, in order to replace recycled rubber granules. However, inorganic alternatives to rubber granules that can deliver the same physical properties regarding performance and resistance to wear are presently not widely available.

For the concrete industry, on the other hand, lightweight expanded clay aggregates or expanded slate aggregates have traditionally been used as filler materials, often with the aim to reduce the overall mass of the concrete product. Expanded clay aggregates and/or expanded slate aggregates have thereto been used in precast concrete, lightweight concrete and structural concrete elements, such as blocks and slabs. However, the manufacturing process for expanded clay aggregates or expanded slate aggregates is energy intensive, requiring heating in an oven, such as a rotary kiln, to temperatures up to 1200° C. Furthermore, large amounts of CO₂ are emitted during the production process. Finally, in many locations the clay that is required to produce expanded clay aggregates, is in short supply, or cannot be mined. The concrete industry is therefore looking for alternative fillers that can reduce both the overall CO₂ footprint of the concrete formulations and the amount of heating energy required during the production process thereof.

Therefore, there is a clear need to provide filler materials that are environmentally friendly and preferably can reuse or reprocess recycled or waste materials. Preferably, such filler materials should be produced by a carbon neutral or low-carbon emissions production process. The filler material should further preferably have a potential for 100% circularity. Finally, the filler materials should meet the physical requirements associated to the end-use, such as a high strength to density ratio, low water absorption properties and resistance to wear and to variable weather conditions.

### SUMMARY OF THE DISCLOSURE

The present invention concerns a thermally bonded granulate comprising 10-50 wt % of a mineral powder, 40-88 wt % of a bonding agent, 1-4 wt % of a strength-enhancing agent and 1-4 wt % of a density-reducing agent. The present invention further concerns the use of the thermally bonded granulate as infill material for artificial turf, as loose fill material in geotechnical applications, as a road material, or as filler material for concrete applications, such as precast concrete, structural concrete, or sprayed concrete. Finally, the present invention concerns a method for producing the thermally bonded granulate, comprising providing a dry mixture of a mineral powder, a bonding agent, a strength enhancing agent and a density-reducing agent, mixing the dry mixture with at least one liquid binder to form a wet mixture, granulating the wet mixture and heating the granulate to above the softening temperature of the bonding agent and the decomposition temperature of the density-reducing agent, to form the thermally bonded granulate.

### FIGURES

FIG. 1 shows a thermally bonded granulate according to the invention.

FIG. 2 shows a sample of a concrete with thermally bonded granules according to the invention as a filler material.

FIG. 3 shows a granulate, after granulation of a wet mixture and before heating.

FIG. 4 shows a thermally bonded granulate, with granule diameters in the range 2-8 mm.

FIG. 5 shows granules after granulating a wet mixture including a liquid organic binder, according to an exemplary embodiment.

FIG. 6 shows thermally bonded granules according to the exemplary embodiment.

### DETAILED DESCRIPTION

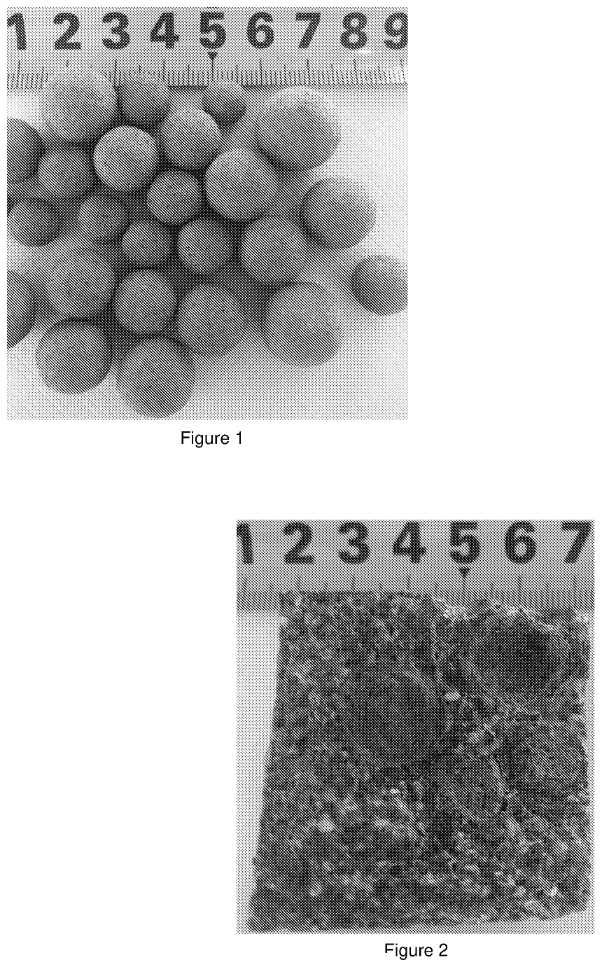

The present invention concerns a thermally bonded granulate, as shown in FIG. 1. The thermally bonded granulate comprises a mineral powder, a bonding agent, a strength-enhancing agent, and a density-reducing agent.

The thermally bonded granulate comprises 10-50 wt % mineral powder. The mineral powder may comprise a quarts sand powder, a silica sand powder, an industrial fines powder, or combinations thereof. Industrial fines powder may comprise fines from the mining industry, construction industry or the incinerated bottom ash industry. Preferably, the mineral powder has a melting temperature above 850° C. The mineral powder has a particle diameter of 1-700 μm, preferably 1-300 μm, most preferably 1-100 μm.

By utilizing a quarts sand or silica sand the thermally bonded granulate comprises natural materials, with no or negligible detrimental impact on the environment. This may be especially advantageous when the thermally bonded granulate is used as an infill material for replacement of natural sand and rubber crumbs in artificial turf, where leakage of heavy metals detrimental to the environment and to users of the artificial turf is avoided. Alternatively, by utilizing industrial fines advantageous industrial waste reduction is achieved. Furthermore, the energy and carbon-emission intensive processing of natural rock into fines and the corresponding transport can be reduced, or even avoided. Especially for locations without natural rock of sufficient quality, this may be a large economic and environmental advantage.

The thermally bonded granulate also comprises 40-88 wt % bonding agent. The bonding agent comprises a glass, preferably a recycled glass. The glass may, for instance, comprise post-consumer recycled glass, soda lime glass, float glass, flint glass, recycled windscreen glass, recycled solar panels, fines from recycled glass, and/or combinations thereof. Advantageously, the thermally bonded granulate thereby contributes to the circular economy and forms an environmentally friendly material. Furthermore, a high compressive strength may be advantageously achieved, due to the high bonding strength of the bonding agent.

The thermally bonded granulate comprises 1-4 wt % of strength-enhancing agent. The strength-enhancing agent comprises silica fume, such as Elkem Microsilica® 971, preferably with CAS number 69012-64-2. The strength-enhancing agent comprises, 82-99.7% wt% SiO₂, more preferably 85-97 wt % SiO₂. The strength-enhancing agent preferably comprises particles, with a particle diameter of less than 1 μm, preferably less than 0.5 μm, more preferably less than 0.25 μm, most preferably 0.15 μm. Advantageously, the strength-enhancing agent results in improved mechanical properties, such as a further increase of the compressive strength, and in an improved durability of the thermally bonded granulate.

The thermally bonded granulate further comprises 1-4 wt % of a density-reducing agent. Preferably, the thermally bonded granulate comprises a decomposed density-reducing agent, comprising a gaseous CO₂ and residual components. The decomposed density-reducing agent may originate from calcium magnesium carbonate CaMg(CO₃)₂, known as dolomite, from calcium carbonate CaCO₃, or combinations thereof. The residual components may comprise CaO and MgO, in the case of dolomite, or CaO, in the case of calcium carbonate. The thermally bonded granulate preferably has a cellular structure inside the bonding material, preferably comprising closed cells. The closed cells are filled with gaseous CO₂. Advantageously, the cellular structure counteracts shrinking of the granules during thermal bonding, as detailed hereinbelow.

The thermally bonded granulate has a bulk density of 400-1000 g/l, preferably 500-900 g/l, most preferably 600-800 g/l. The low bulk density is advantageous in applications where weight-reduction is important, such as light weight concrete.

The granules of the thermally bonded granulate have a diameter of 0.5-18 mm. Preferably, the granules of the thermally bonded granulate have a spherical or semi-spherical shape. The sphericity of the granules ranges from 0.5-1, preferably from 0.8-1, most preferably from 0.9-1.

The average compressive strength of the thermally bonded granulate ranges from 15-50 MPa, preferably from 18-40 MPa, most preferably from 20-30 MPa. The average compressive strength is determined by averaging the compressive strength of randomly selected granules, preferably five or more randomly selected granules. For each selected granule the surface area in mm² is determined, by measuring the granule diameter and calculating the corresponding surface area, assuming a spherical granule shape. The compressive strength of a randomly selected granule is then determined by applying an uniaxial compressive force to the granule and dividing the applied compressive force by the determined granule surface area. The granule is compressed until failure occurs and the compressive strength refers to the highest value measured before granule failure.

The thermally bonded granulate may be used as an infill material for artificial turf systems, as filler, or aggregate, in precast concrete, in structural concrete, in sprayed concrete, also known as shotcrete, or in any other concrete formulation where a filler or aggregate is needed. Alternatively, the thermally bonded granulate may be used as loose fill material in geotechnical applications, or as a road material.

A product comprising the thermally bonded granulate material is also provided. The product may comprise an infill material for artificial turf systems. Preferably, the granules of the thermally bonded granulate have a diameter from 0.5-5 mm, preferably 0.8-2.5 mm, more preferably 0.9-2.4 mm, and most preferably 1.0-2.0 mm. Advantageously, the thermally bonded granulate may replace both natural sand and rubber crumbs as filler materials. Furthermore, the thermally bonded granulate can be collected at end of life of the artificial turf and be reused as a filler material, or reprocessed into a new filler material.

Alternatively, the product may comprise a filler for a concrete application. Preferably, the granules of the thermally bonded granulate have a diameter from 0.5-18 mm, preferably 1-16 mm, most preferably 2-12 mm. A sample of concrete including a product according to the invention is shown in FIG. 2.

According to a further aspect of the invention, a method for preparing a thermally bonded granulate according to the invention is described. The method comprises providing mineral powder, bonding agent, strength-enhancing agent, and density-reducing agent.

The mineral powder may comprise a quarts sand powder, a silica sand powder, an industrial fines powder, or any combinations thereof. Industrial fines powder may comprise fines from the mining industry, construction industry, or the incinerated bottom ash industry. Preferably, the mineral powder has a melting temperature above 850° C. The mineral powder has a particle diameter of 1-700 μm, preferably 1-300 μm, most preferably 1-100 μm.

The bonding agent comprises a glass powder, preferably a recycled glass powder. The recycled glass may, for instance, comprise post-consumer recycled glass, soda lime glass, float glass, recycled windscreen glass, recycled solar panels and/or combinations thereof. The recycled glass is ground, and preferably sieved, to provide a glass powder. The glass powder has a particle diameter of 1-700 μm, preferably 1-300 μm, most preferably 1-70 μm. The bonding agent preferably has a softening temperature in the range 660° C.-765° C.

The strength-enhancing agent comprises silica fume. The strength-enhancing agent is provided in powder form. The strength-enhancing agent may have CAS number 69012-64-2 and may comprise Elkem Microsilica® 971. The strength-enhancing agent comprises, 82-99.7% wt % SiO₂, more preferably 85-97 wt % SiO₂. The strength-enhancing agent preferably comprises particles with a diameter less than 1 μm, preferably less than 0.5 μm, more preferably less than 0.25 μm, most preferably 0.15 μm. The strength-enhancing agent provides improved mechanical properties, such as improved compressive strength, and improved durability of the thermally bonded granulate.

The density-reducing agent comprises calcium magnesium carbonate CaMg(CO₃)₂, known as dolomite, calcium carbonate, CaCO₃, or combinations thereof. The density-reducing agent is provided in powder form. Preferably, the density-reducing agent comprises particles with a diameter of less than 150 μm, preferably less than 75 μm, most preferably less than 25 μm. The density-reducing agent undergoes thermal decomposition into CO₂ and residual components. For dolomite the residual components are MgO and CaO; for calcium carbonate the residual component is CaO. The release of gaseous CO₂ into the softened bonding material forms a closed-cell structure. For dolomite, thermal decomposition starts at 440° C. and completes at 740° C. For calcium carbonate thermal decomposition starts at 650° C. and completes at 765° C.

The method comprises pre-mixing the mineral powder, the bonding agent, the strength-enhancing agent, and the density-reducing agent, to provide a dry mixture. The dry mixture comprises 10-50 wt % mineral powder, 40-88 wt % bonding agent, 1-4 wt % strength enhancing agent, and 1-4 wt % density-reducing agent. Pre-mixing is performed in a mixing apparatus, such as a granulating mixer. The granulating mixer may comprise mixing pan, in which the dry mixture is formed. The mixing pan is rotatable around a rotational axis. The rotational axis of the mixing pan is preferably inclined with respect to the vertical direction. The granulating mixer may further comprise an eccentric mixing tool, located inside the mixing pan. The eccentric mixing tool may comprise one or more mixing blades. The granulating mixer may optionally comprise a static tool, such as a scraper. Alternatively, the mixing apparatus may be a rotary drum granulator.

The method further comprises providing at least one liquid binder, and mixing the least one liquid binder into the dry mixture. Thereby a wet mixture is provided. The liquid binder may be chosen from a lignin biopolymer, such as a lignosulfonate, or a sugar solution, or a gelatin, or water. Preferably the liquid binder is an organic liquid binder. The liquid binder may be provided in 1-15 wt % with respect to the dry mixture, preferably 2.5-10 wt % with respect to the dry mixture, most preferably 5 wt % with respect to the dry mixture. Preferably, the liquid binder is added to the dry mixture in the mixing apparatus. The liquid binder may, for instance, be added to the dry mixture by spraying, through one or more spray nozzles, or by pouring, through an appropriate port in the mixing pan. By mixing the liquid binder into the dry mixture, a wet mixture is formed. The wet mixture is preferably mixed to form a uniform wet mixture.

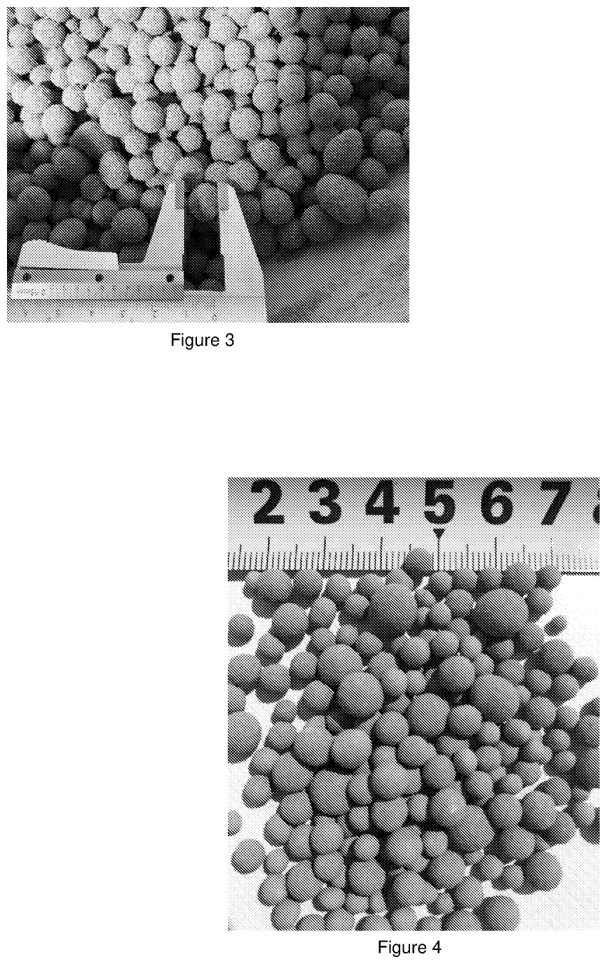

A granulate is formed from the wet mixture, as shown in FIG. 3. Continued mixing wets the particles of the dry mixture with the liquid organic binder. The wetted particles agglomerate to form granules, held together by capillary and/or surface tension forces exerted by the liquid binder. The resulting granules preferably have a diameter in the range 0.5-5 mm. The granule size is substantially controlled by the angle of inclination of the mixing pan and/or the rotational speed of the mixing pan, as well as by geometry and rotational speed of the optional eccentric mixing tool. Optionally, the granules may be sieved upon exiting the mixing apparatus, thereby filtering out undersized and oversized granules or non-granulated particles.

In order to produce granules with a large diameter, the granulate may optionally be transferred from the mixing apparatus to a disc granulator. The granulate may, for instance, exit the mixing apparatus to a feed apparatus, such as a table feeder or a feed conveyor. From the feed apparatus, the granulate is fed into a disc granulator. In the disc granulator the granulate undergoes further agglomeration, or coalescence, to form granules with a diameter in the range 5-18 mm. The disc granulator comprises a mixing pan. The mixing pan is rotatable around a rotational axis. Preferably, the mixing pan is inclined along its rotational axis with respect to the vertical direction. A large diameter granulate is thus obtained, which may be advantageous for use in lightweight concrete applications, where the thermally bonded granulate may replace high density natural aggregates.

Following granulation, the granulate may optionally be dried. Thereby, surface moisture is removed from the granules and granule adhesion, or stickiness, may be reduced. This may be especially advantageous when using an organic liquid binder. Preferably, the granulate is dried at a temperature ranging from ambient to 200° C. Drying occurs at a temperature below the activation temperature of the density-reducing agent and below the softening temperature of the bonding agent. The granulate may, for instance, be dried in an oven, a hot air chamber, or the like. Alternatively and/or additionally, the granulate may be surface dried in the mixing apparatus or in the disc granulator. Surface drying may be achieved by adding a powder coating the granule surfaces. The powder coating may comprise an aluminum powder, such as Al₂ or Al₃ powder, silica powder, or ceramic powder. The particles of the powder coating preferably have a diameter of less than 40 μm, more preferably less than 1 μm. By applying the powder coating a dry granule surface having an improved flowability may be created. Thereby the risk of sticking of granules is reduced. Furthermore, the thermally bonded granulate may have improved surface properties, such as a smoother surface structure or reduction of water absorption. The finer the powder coating and/or the more powder coating is applied, the smoother the surface of the thermally bonded granulate. For infill material for artificial turf a smooth surface may be advantageous, to reduce ingress of water into the thermally bonded granules and thereby prevent frost damage. For concrete applications a rough surface may be advantageous, to improve bonding of the amorphous concrete to the thermally bonded granules.

Next, a thermally bonded granulate is produced. A thermally bonded granulate with a granule diameter in the range 2-8 mm is shown in FIG. 4. Thereto, the granulate is heated in an oven, such as a rotary tube furnace or a rotary kiln. The granulate may, for example, be transported through the oven in a rotational movement, at a certain rotational speed and angle. Alternatively, the granulate may be transported through the oven on a conveyor belt. In the oven, the granulate is heated to a maximum temperature in the range 710° C.-900° C., preferably 750° C.-849.9° C., most preferably 780° C.-820° C. In each case, the heating temperature is lower than the melting temperature of the mineral powder. The granulate is heated for a period of 1-60 min, preferably 2-15 min, most preferably 3-8 min.

During heating, the bonding agent softens and adheres to the other components of the granulate to form a thermally bonded granulate. Furthermore, the density-reducing agent undergoes thermal decomposition into gaseous CO₂ and residual components. The gaseous CO₂ is encapsulated in the softened bonding agent, thereby forming a cellular structure. Cell formation counteracts the heat-driven compaction of the granules during thermal bonding. Heat-driven compaction occurs due to reduction of interstitial pores when the bonding agent softens and may lead to up to 30% of volume loss for granules without density-reducing agent. Advantageously, shrinking of the granules during thermal bonding is thereby prevented. The heating temperature should preferably not exceed 900° C., as the bonding agent may become so liquid that cells formed by the expanding CO₂ may merge, or the CO₂ may escape from the granulate.

Finally, the thermally bonded granulate exits the oven and is subsequently cooled down to ambient temperature. Thereby, the thermally bonded granulate, see FIG. 4, is ready for use, or for optional further treatment. Such further treatment may, for instance, comprise mixing of the thermally bonded granulate with other components, or spraying and/or coating the thermally bonded granulate with a coating substance.

### Exemplary Embodiment

According to an exemplary embodiment a dry pre-mixture was prepared comprising 450 g of quarts sand powder. The quarts sand powder has a particle size up to 300 μm. The dry mixture further comprises 500 g of glass powder. The glass powder comprises soda lime glass, originating from recycled flat glass, and has a particle size below 72 μm. The dry mixture further comprises 30 g of dolomite powder and 20 g of silica fume (Elkem Microsilica® 971).

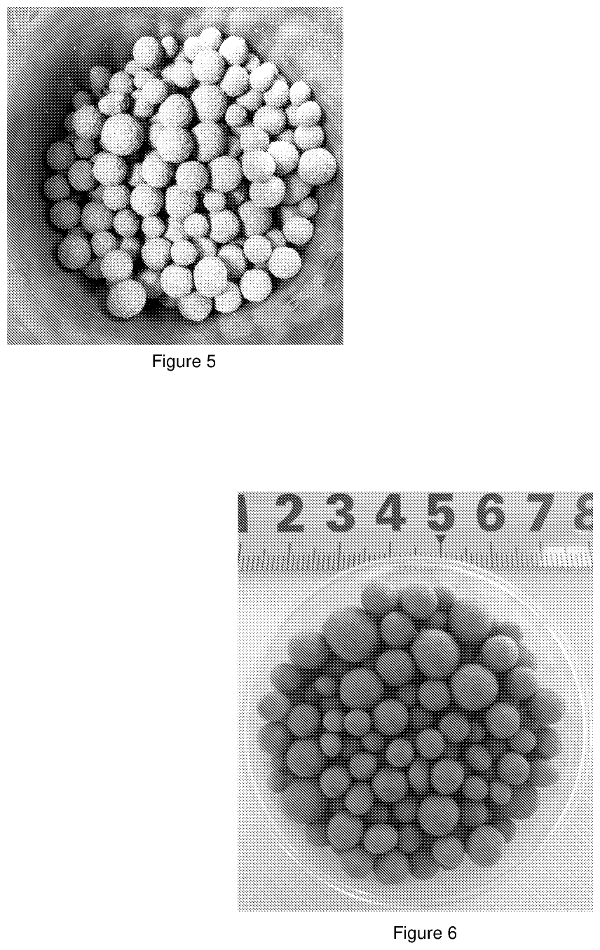

The dry pre-mixture was then sprayed with 50 g of a Lignin Biopolymer solution to form a wet mixture. The wet mixture was next granulated into granules, see FIG. 5, using a disc granulator. The granules were surface dried by adding hot air of 50° C. for 2 minutes.

The granulates were then placed inside a rotary tube furnace at a temperature of 810° C. for 5 min to produce a thermally bonded granulate, shown in FIG. 6.

The samples produced in the exemplary embodiment were investigated using a materials testing machine known as Z2.5 test Control Il made by Zwick/Roell in Ulm, Germany. Compression was carried out with a constant feed of 1 mm min⁻¹. The compression force and compaction distance were collected by test Xpert II software also provided by the manufacturer Zwick/Roell. The first major drop in compression force was allocated to particle breakage. The sample surface area was determined by manually measuring the granule diameter using a caliper and then calculating the corresponding spherical granule surface area. The compaction force divided by surface area (N/mm²) equals the compressive strength (MPa).

The results for the compressive strength measurements for six randomly selected thermally bonded granules, with a size from 2-8 mm, obtained via the exemplary embodiment are shown in Table 1. The average compressive strength, determined by averaging the compressive strength of the sampled particles 1-6 in Table 1, equals 19.9 MPa. The standard deviation of the compressive strength, determined for the sampled particles 1-6 in Table 1, equals 2.01 MPa.

| Particle nr. | 1 | 2 | 3 | 4 | 5 | 6 |
|---|---|---|---|---|---|---|
| Compressive | 18.7 | 19.19 | 24 | 18.73 | 19.77 | 19.54 |
| strength (MPa) | | | | | | |

1. A thermally bonded granulate comprising:
10-50 wt % of a mineral powder, wherein the mineral powder comprises a quarts sand powder, an industrial fines powder, or a combination thereof, and wherein the mineral powder has a particle diameter of 1-300 μm;
40-88 wt % of a bonding agent, wherein the bonding agent comprises a recycled glass;
1-4 wt % of a strength-enhancing agent, wherein the strength-enhancing agent comprises silica fume, comprising particles with a diameter less than 1 μm; and
1-4 wt % of a density-reducing agent, wherein the density-reducing agent comprises dolomite, calcium carbonate, or combinations thereof.

2. The thermally bonded granulate according to claim 1, wherein the mineral powder has a melting temperature above 850° C.

3. The thermally bonded granulate according to claim 1, wherein the mineral powder has a particle diameter of 1-100 μm.

4. The thermally bonded granulate according to claim 1, wherein the recycled glass comprises post-consumer recycled glass, soda lime glass, float glass, flint glass, recycled windscreen glass, recycled solar panel glass, fines from recycled glass processing, and/or combinations thereof.

5. The thermally bonded granulate according to claim 1, wherein the bonding agent has a softening temperature in the range 660° C.-765° C.

6. The thermally bonded granulate according to claim 1, wherein the granules of the thermally bonded granulate have a diameter in the range 0.5-18 mm.

7. The thermally bonded granulate according to claim 1, wherein the thermally bonded granulate has a bulk density from 400-1000 g/l, preferably 500-900 g/l, most preferably 600-800g/l.

8. An infill material for artificial turf comprising a thermally bonded granulate material according to claim 1, wherein the granules of the thermally bonded granulate have a diameter in the range from 0.5-5 mm, preferably 0.8-2.5 mm, more preferably 0.9-2.4 mm, and most preferably 1.0-2.0 mm.

9. A filler for concrete applications comprising a thermally bonded granulate according to claim 1, wherein the granules of the thermally bonded granulate have a diameter from 0.5-18 mm, preferably 1-16 mm, most preferably 2-12 mm.

10. Use of a thermally bonded granulate according to claim 1, as infill material for artificial turf, as loose fill material in geotechnical applications, as a road material, or as filler material for concrete applications, such as precast concrete, structural concrete, or sprayed concrete.

11. A method for producing a thermally bonded granulate according to claim 1, the method comprising:
providing a dry mixture of the mineral powder, the bonding agent, the strength enhancing agent and the density-reducing agent;
mixing the dry mixture with at least one liquid binder to form a wet mixture;
granulating the wet mixture to form a granulate; and
heating the granulate to above the softening temperature of the bonding agent and the decomposition temperature of the density-reducing agent, where the heating temperature is lower than the melting temperature of the mineral powder, to form a thermally bonded granulate.

12. The method according to claim 11, wherein the dry mixture comprises 10-50 wt % mineral powder, 40-88 wt % bonding agent, 1-4 wt % strength enhancing agent, and 1-4 wt % density-reducing agent.

13. The method according to claim 11, wherein the granulate is heated for 1-60 min, more preferably for 2-15 min, most preferably for 3-8 min.

14. The method according to claim 11, wherein the dry mixture is formed in a mixing apparatus and wherein the liquid binder is added to the dry mixture in the mixing apparatus.

15. The method according to claim 11, wherein the liquid binder is chosen from a lignin biopolymer, a sugar solution, a gelatin, or water.

16. The method according to claim 11, wherein the liquid binder is provided in 1-15 wt %, preferably 2.5-10 wt %, most preferably 5 wt %, with respect to the dry mixture to form a wet mixture.

17. The method according to claim 14, wherein the granulate is sieved upon exiting the mixing apparatus.

18. The method according to claim 14, wherein the granulate is transferred from the mixing apparatus to a disc granulator to form granules with a diameter in the range 5-18 mm.

19. The method according to claim 11, wherein the granulate is dried after granulation, at a temperature below the activation temperature of the density-reducing agent and below the softening temperature of the bonding agent.

20. The method according to claim 19, wherein the granulate is surface dried by adding a powder coating the granule surfaces.
